(19) United States
(12) Patent Application Publication
(10) Pub. No.: US 2014/0041142 A1
(43) Pub. Date: Feb. 13, 2014

(54) Safety Apparatus and System for a Two-Stage Dust Collection Vacuum Device

(71) Applicant: Emerson Electric Co., (US)

(72) Inventor: John L. Theising, St. Peters, MO (US)

(73) Assignee: EMERSON ELECTRIC CO., St. Louis, MO (US)

(21) Appl. No.: 13/759,789

(22) Filed: Feb. 5, 2013

Related U.S. Application Data
(60) Provisional application No. 61/595,104, filed on Feb. 5, 2012.

(51) Int. Cl. B27G 3/00

(52) U.S. Cl. CPC B27G 3/00
USPC 15/246.2

(57) ABSTRACT

Described is an apparatus and system for improving the safety of a vacuum device including a first intake cavity, a second intake cavity that can be coupled to a first housing, and a baffle disposed within the first intake cavity to limit the access to the blades of a vacuum pumping device. Alternatively, the apparatus can include a first intake cavity, a second intake cavity, and a baffle. The baffle can be adapted to channel solid particulates to a second intake cavity though a funneling motion. The apparatus can further include an external cover for limiting access to the blades of a vacuum pumping device. The system can include an intake interface, a first housing to receive a pumping device, a second housing device, and a collection unit. The system can further include an apparatus for limiting the access to the blades of a vacuum pumping device.

### CROSS REFERENCE TO RELATED APPLICATIONS

This application claims priority to U.S. Provisional Patent Application Ser. No. 61/595,104, filed Feb. 5, 2012, the contents of which are incorporated herein by reference in its entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein are directed generally to an apparatus and system for improving the safety of a two-stage dust collecting vacuum device. In one of the aspects, the invention relates to an apparatus, wherein the apparatus is adapted to employ a baffle coupled to an intake cavity to limit access to the blades of a vacuum device. In another aspect, the apparatus can include an external cover for limiting access to the blades of a vacuum pumping device. In further aspects, the system can include a collection unit for collecting dust originating from a first intake cavity.

2. Description of the Related Art

Woodworking tools and other held-held or stationary power tools are commonly employed to grind, saw, polish, plane, or drill building materials for various construction, woodworking, or home improvement projects. These activities generate grindings, chips, and other solid particularities, such as saw dust and other debris throughout the various tools' operations. These particulates can create a safety hazard if not disposed of properly. For example, the residual wood chips and saw dust generated during a woodworking tool's operation can cause respiratory complications if inhaled by the operator. Furthermore, the debris can create the risk of a potential fire hazard if it is not properly collected and removed from the operator's work area.

In order to mitigate these risks, operators have attempted to use standard vacuum cleaners to collect the dust and other particulates. Standard vacuum cleaners, however, are typically incapable of filtering and collecting the debris and other large solid particulates generated by most woodworking tools. Because standard vacuum cleaners are not designed to handle such debris, their hoses and filters often become clogged or even damaged throughout the vacuuming process.

In order to overcome the drawbacks of standard vacuum cleaners, operators commonly employ large vacuum systems with specialized hoses and filters for retaining and collecting the particulates generated during the tools' operations. These vacuum systems employ larger hoses, stronger air pumps, and alternative filtering systems in order to prevent dust and debris from clogging or damaging the vacuum cleaner.

For example, U.S. Patent Publication No. 2004/0187449 to Witter describes a dust collection system for portable sanding or grinding equipment that employs a cyclone separator mounted directly on a woodworking tool or machine. During its operation, the dust is concentrated in the cyclone and a small volume air flow moves the dust through an elongated flexible hose or duct to a remote duct collection station. A cyclonic separator at the remote station separates the dust from the air flow and deposits it in a collection tank or drum.

U.S. Patent Publication No. 2004/0035092 to Wang describes a dust-collection device with a hollow cylindrical body positioned over a cart to collect debris in a dust collection bag. The device collection bag is configured to be quickly engaged and disengaged from the dust collection device for easy replacement.

U.S. Patent Publication No. 2005/0132679 to Tyburk describes a dust collection system and related airlock that includes a housing defining an interior chamber, an entrance hole and an exit hole, each hole being in fluid communication with the interior chamber. This configuration creates an airlock chamber to allow particulate material to enter and exit the airlock without the need for a collection bin being sealed to the dust collection system.

Although these prior art solutions can be effective for removing dust and debris during the operation of woodworking tools and the like, they create an inherent safety risk in their design. More specifically, collection devices such as the ones described in the foregoing examples must employ a high-powered vacuum pump in order to create the requisite suction to collect the debris. These pumps often comprise rapidly rotating blades that can pose a significant risk if an operator accidentally contacts the blades while coupling or decoupling the collection bags or vacuum hoses from the remaining elements of the vacuum device. Accordingly, the inventions disclosed and taught herein are directed to an apparatus and system for improving the safety of a vacuum device for collecting dust and debris that overcomes the problems set forth above.

### BRIEF SUMMARY OF THE INVENTION

The present invention is directed to an apparatus and system for improving the safety of a vacuum device. The apparatus and system employ multiple safety features to prohibit an operator from contacting the blades of the vacuum device during its operation.

The disclosure provides an apparatus and system for improving the safety of a vacuum device including a first intake cavity, a second intake cavity that can be coupled to a first housing, and a baffle disposed within the first intake cavity to limit the access to the blades of a vacuum pumping device. Alternatively, the apparatus can include a first intake cavity, a second intake cavity, and a baffle. The baffle can be adapted to channel solid particulates to a second intake cavity though a funneling motion. The apparatus can further include an external cover for limiting access to the blades of a vacuum pumping device. The system can include an intake interface, a first housing to receive a pumping device, a second housing device, and a collection unit. The system can further include an apparatus for limiting the access to the blades of a vacuum pumping device.

The disclosure also provides an apparatus for improving the safety of a vacuum device that can include a first intake cavity and a second intake cavity. The first intake cavity can be adapted to be coupled to a conduit and the second intake cavity can be adapted to be coupled to a first housing. The second intake cavity can include one or more flanges that can be adapted to couple the apparatus to the first housing.

The apparatus can further include a baffle that can be adapted to be disposed within the first intake cavity in order to limit access from the first intake cavity to the first housing. The baffle can be disposed within the first intake cavity to partially obstruct the flow of material though the first intake cavity. Further, the apparatus can include a slot that can be adapted to adjust the orientation of the first intake cavity with respect to the first housing.

Additionally, the apparatus can include a first tubular section and a second tubular section. The diameter of at least a portion of the first tubular section can be smaller than the diameter of the second tubular portion. The apparatus can further include a tubular joint that can be adapted to couple the first tubular section to the second tubular section. The tubular joint can be adapted to be bent at an angle of approximately ninety degrees.

The disclosure also provides a system for improving the safety of a vacuum device that can include an intake interface, a first housing that can be adapted to receive a pumping device, and an apparatus that can be coupled to the intake interface. The apparatus can include a first intake cavity and a second intake cavity. The first intake cavity can be adapted to be coupled to a conduit and the second intake cavity can be adapted to be coupled to a first housing.

The system's apparatus can further include a collection unit that can be adapted to collect solid particulates originating from the first intake cavity. The collection unit can include a first collection unit and a second collection unit. The second collection unit can be adapted to collect solid particulates originating from the first intake cavity. Furthermore, the system's apparatus can include a baffle that can be adapted to be disposed within the first intake cavity in order to limit access from the first intake cavity to the first housing.

The system can further include a collection unit interface coupled to the collection unit second housing that can be adapted to separate material originating from the first intake cavity and a safety device that can be adapted to limit access from the second housing to the first housing. The safety device can further include a safety device flange. The safety device can further include at least one safety device baffle. Furthermore, the system can include a vacuum device that can be adapted to be coupled to the conduit.

The disclosure also provides an apparatus for improving the safety of a vacuum device that can include a first intake cavity and a second intake cavity. The first intake cavity can be adapted to be coupled to a conduit and the second intake cavity can be adapted to be coupled to a first housing. The apparatus can further include an external cover that can be adapted to be coupled to, or decoupled from, at least a portion of a baffle. The baffle can be adapted to channel solid particulates originating from the first intake cavity to the second intake cavity in a partially cyclical fashion. Furthermore, the baffle can be adapted to channel solid particulates by funneling the solid particulates from the first intake cavity to the second intake cavity.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a side view of a first embodiment of an apparatus for improving the safety of a vacuum device.

FIG. 2 illustrates an isometric front view of a first embodiment of an apparatus for improving the safety of a vacuum device.

FIG. 3 illustrates an isometric bottom view of a first embodiment of an apparatus for improving the safety of a vacuum device.

FIG. 4 illustrates a first embodiment of a system for improving the safety of a vacuum device.

FIG. 5A illustrates an isometric front view of the bottom portion of a second embodiment of an apparatus for improving the safety of a vacuum device.

FIG. 5B illustrates an isometric front view of the top portion of a second embodiment of an apparatus for improving the safety of a vacuum device.

FIG. 6A illustrates an isometric view of a first embodiment of a second housing including a collection unit interface and a safety device.

FIG. 6B illustrates a cross-sectional isometric view of a first embodiment of the second housing including a collection unit interface and a safety device.

FIG. 6C illustrates an isometric back view of a first embodiment of a safety device flange.

FIG. 6D illustrates an isometric front view of a first embodiment of the safety device flange.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The disclosure provides an apparatus and system for improving the safety of a vacuum device including a first intake cavity, a second intake cavity that can be coupled to a first housing, and a baffle disposed within the first intake cavity to limit the access to the blades of a vacuum pumping device. Alternatively, the apparatus can include a first intake cavity, a second intake cavity, and a baffle. The baffle can be adapted to channel solid particulates to a second intake cavity though a funneling motion. The apparatus can further include an external cover for limiting access to the blades of a vacuum pumping device. The system can include an intake interface, a first housing to receive a pumping device, a second housing device, and a collection unit. The system can further include an apparatus for limiting access to the blades of a vacuum pumping device.

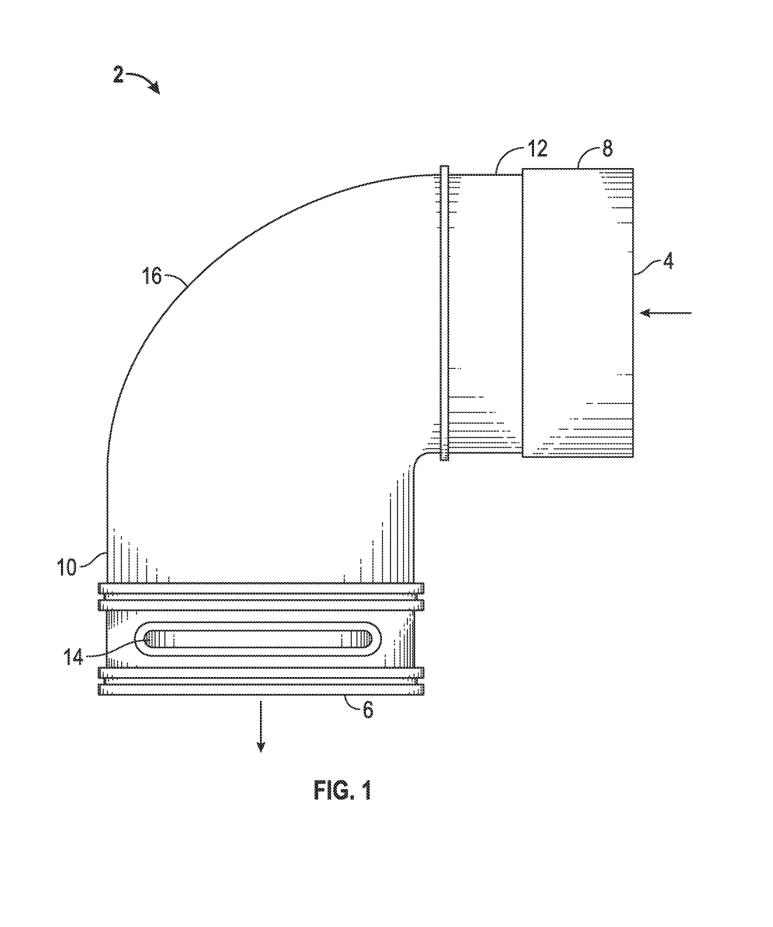

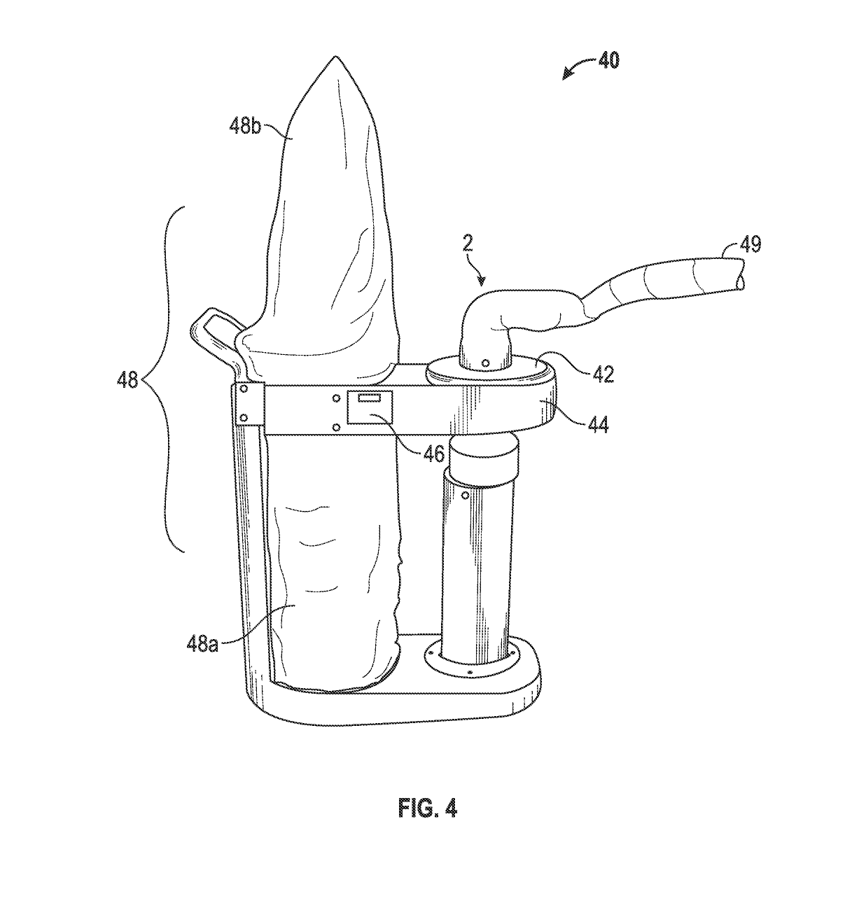

Turning now to the figures, FIG. 1 illustrates a side view of a first embodiment of an apparatus for improving the safety of a vacuum device. The apparatus 2 can include a first intake cavity 4 adapted to be coupled to a conduit 49 (as shown in FIG. 4) and second intake cavity 6 adapted to be coupled to a first housing 44 (as shown in FIG. 4). The first intake cavity 4 and the second intake cavity 6 can be distally located from each other on opposite terminating edges of the apparatus 2. The apparatus 2 can further include a first tubular section 8, a second tubular section 10, and a slot 14 that can be adapted to adjust the orientation of the first intake cavity with respect to the first housing.

At least a portion of the first tubular section 8 can include a first tapered section 12. The diameter of the first tapered section 12 can be smaller than the diameter of at least a portion of the first tubular section 8. The apparatus 2 can further include a tubular joint 16 that can couple the first tubular section 8 with the second tubular section 10. The tubular joint 16 can be adapted to be bent at an angle of approximately ninety degrees.

The first intake cavity 4 can include any cavity, slot, slit, opening, vent, void, or other recessed or hollow space capable of receiving any solid, liquid, gas, or gaseous-like material (depicted as a series of arrows in the figures). For example, the first intake cavity 4 can be configured to permit solid particulates to flow from a conduit 49 (as shown in FIG. 4) through to the first tubular section 8 of the apparatus 2. In an exemplary and non-limiting illustrative embodiment, the first intake cavity 8 can be configured as a circular opening positioned at a terminating edge of the first tubular section 8. Alternatively, the first intake cavity 4 can be configured to be shaped as any other regularly or irregularly geometrically shaped openings capable of receiving solid, liquid, gas, or gaseous-like materials.

The second intake cavity 6 can include any cavity, slot, slit, opening, vent, void, or other recessed or hollow space capable of receiving any solid, liquid, gas, or gaseous-like material. For example, the second intake cavity 6 can be configured to permit solid particulates to flow from the first intake cavity 4 to a terminating edge of the second tubular section 10. In an exemplary and non-limiting illustrative embodiment, the second intake cavity 6 can be configured as a circular opening positioned at a terminating edge of the second tubular section 10. Alternatively, the second intake cavity 6 can be configured to be shaped as any other regularly or irregularly geometrically shaped opening capable of receiving solid, liquid, gas, or gaseous-like materials.

In an exemplary and non-limiting illustrative embodiment, the first tubular section 8 can have a uniform internal diameter and a non-uniform external diameter. For example, the first tubular section 8 can include a first tapered section 12 where at least a portion of the first tubular section 8 has an external diameter that is smaller than the exterior diameter of the remaining portions of the first tubular section 8. The internal diameter of the first tubular section 8 can be uniform throughout the entire length of the first tubular section 8. Alternatively, at least one portion of the internal diameter of the first tubular section 8 can be smaller than another portion of the first tubular section 8.

The term “diameter” as used herein and throughout the disclosure can refer to the greatest distance between two edges or corners of a cross-sectional area along a straight line. For example, if a cross-section of the first tubular section 8 is circular, the diameter is equal to twice the radius of the circle. If a cross-section of the first tubular section is rectangular, the diameter is the distance measured diagonally between two corners of the rectangular.

The first tapered section 12 can be employed as a means to couple the first tubular section 8 to another apparatus (not shown), for example, a vacuum hose, which in turn may be coupled to a vacuum apparatus or similar device, or to a vacuum tool to assist in debris pickup. The first tapered section's 12 smaller external diameter (as compared to the remaining portions of the first tubular section 8) can act as a groove to help secure the vacuum hose (not shown) in place when coupled to the apparatus 2. Alternatively, the first tapered section 12 can be replaced with at least one coupling element (not shown). The coupling element can include a tab, notch, slot, or any other means for coupling a vacuum attachment or any other apparatus to the first tubular section 8. For example, the first tapered section 12 can be replaced by a flexible tab capable of coupling a vacuum hose to, or decoupling a vacuum hose from, the first tubular section 8.

The first tubular section 8 can include any tube, pipe, hollow or partially hollow cylinder, duct, vent, or any other conduit capable of allowing the passage of a solid, liquid, gas, or gaseous-like material from a point of origin to a point of destination. In an exemplary and non-limiting illustrative embodiment, the first tubular section 8 can include at least a portion that is a hollow cylinder with a circular circumference. Alternatively, the first tubular section 8 can include a hollow conduit of other shapes and sizes. For example, the first tubular section 8 can include a conduit that includes a rectangular cross section for permitting material to flow from the first intake cavity 4 to the tubular joint 16.

The second tubular section 10 can include any tube, pipe, hollow or partially hollow cylinder, duct, vent, or any other conduit capable of allowing the passage of a solid, liquid, gas, or gaseous-like material from a point of origin to a point of destination. In an exemplary and non-limiting illustrative embodiment, the second tubular section 10 can include at least a portion that is a hollow cylinder with a circular circumference. Alternatively, the second tubular section 10 can include a hollow conduit of other shapes and sizes. For example, the second tubular section 10 can include a conduit that includes a rectangular cross section for permitting material to flow from the tubular joint 16 to the second intake cavity 6.

The slot 14 can include any slot, slit, notch, groove, aperture, or other narrow opening that can be adapted to adjust the orientation of the first intake cavity 6 with respect to the first housing 44 (as shown in FIG. 4). The slot 14 can be coupled to an intake interface 42 (as shown in FIG. 4), the first housing 44 (as shown in FIG. 4), or both, to permit the apparatus 2 to rotate the position of the first intake cavity 4 without decoupling the apparatus 2 from the intake interface 42 (as shown in FIG. 4), the first housing 44 (as showing in FIG. 4), or both.

For example, the intake interface 42 (as shown in FIG. 4) can include a slot receiving element (not shown) such as a bulge, bump, nub, or other protuberance to be received by the slot 14 when the apparatus 2 is coupled to the intake interface 42 (as shown in FIG. 4). In this example, the slot receiving element (not shown), while coupled to the slot 14, can permit an apparatus (such as a vacuum hose) to freely rotate about a vertical axis of the apparatus 2. The slot 14 can be configured to permit the apparatus 2 to rotate up to and including ninety degrees about the vertical axis. Alternatively, the slot 14 can be configured so that the apparatus 2 can rotate up to and including 360 degrees about the vertical axis. By permitting this rotation, the position of the first intake cavity 4 can easily be adjusted without decoupling the apparatus 2 from the intake interface 42 (as shown in FIG. 4). This rotation can provide an operator with greater freedom of movement of the apparatus coupled to the first tubular section 8 of apparatus 2.

The tubular joint 16 can include any attachment, coupling, fastener, link, or any other point of connection between the first tubular section 8 and the second tubular section 10. In an exemplary and non-limiting illustrative embodiment, the tubular joint 16 can be an elbow-shaped connector for disposing the first intake cavity 4 and the second intake cavity 6 at a ninety degree with respect to one another. Alternatively, the tubular joint 16 can include a connector for disposing the first intake cavity 4 and the second intake cavity 6 at any angle other than a ninety degree angle. In one embodiment, the tubular joint 16 can be omitted altogether. In this example, the first tubular section 8 and the second tubular section 10 can be disposed at 180-degree angles with respect to one another.

The tubular joint 16 can function as a conduit to permit material to flow from the first tubular section 8 to the second tubular section 10. The internal diameter of the tubular joint 16 can be the same as the internal diameter of both the first tubular section 8 and the second tubular section 10. Alternatively, the tubular joint can have an interior diameter that is different than one or more of the internal diameters of the first tubular section 8 and the second tubular section 10.

Although apparatus 2 is described throughout the disclosure as requiring at least a first intake cavity 4, a second intake cavity 6, a first tubular section 8, a second tubular element 10, and a tubular joint 16, other embodiments have been contemplated as well. For example, the first intake cavity 4 can include more than one first intake cavities 4 and more than one first tubular sections 8. In this example, the apparatus 2 can be embodied as a Y-shaped apparatus with two first intake cavities 4, and a single second intake cavity 6. Each of the first intake cavities 4 can include at least one baffle 18. Other configurations are contemplated as well. For example, the first intake cavity 4 can include more than one first intake cavity 4 and more than one first tubular section 8; the second intake cavity 6 can include more than one second intake cavity 6 and more than one second tubular section 10. This example, the apparatus 2 can be embodied as an X-shaped apparatus with two first intake cavities 4, and two second intake cavities 6.

The apparatus 2 can be made of injection-molded plastic, such as polypropylene, polyethylene, ABS, thermoplastics, polymerizing resin, polyacetal, polystyrene, and/or similar materials, with or without filling additives like fibers, chalks, or other flowable and settlable materials that may be injection-molded, cast, or low-pressure molded, in accordance with conventional practice.

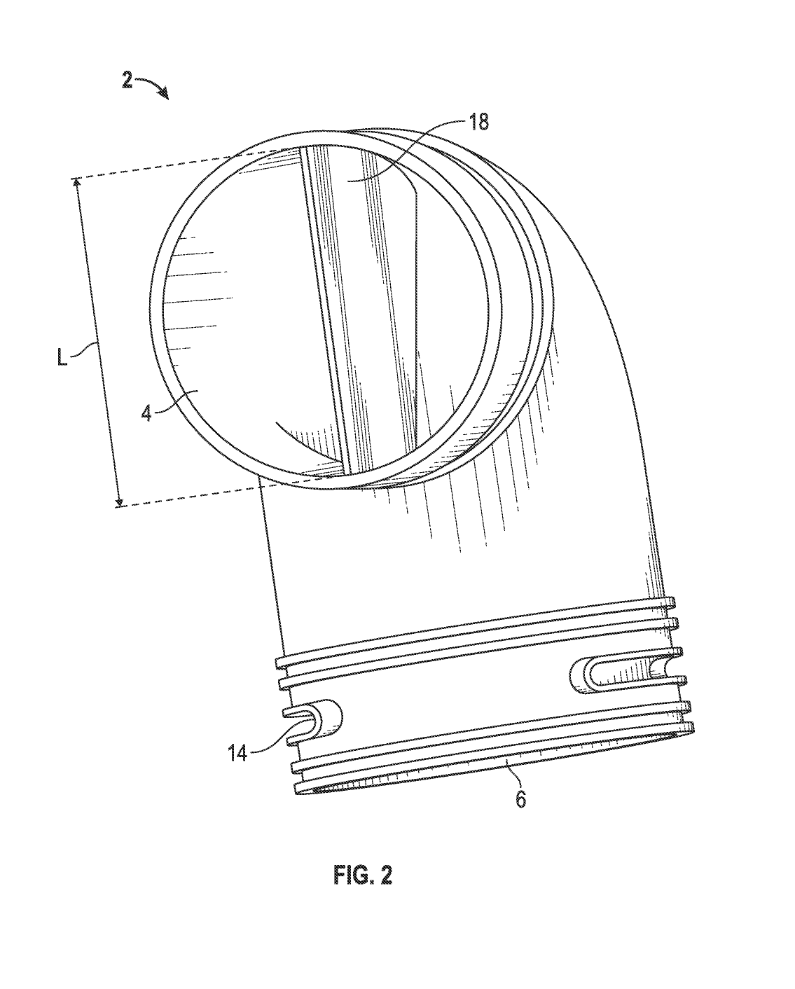

FIG. 2 illustrates an isometric front view of a first embodiment of an apparatus for improving the safety of a vacuum device. The apparatus 2 can include a first intake cavity 4, a second intake cavity 6, and a slot 14. The apparatus can further include a baffle 18 that can be adapted to be disposed within the first intake cavity 4 in order to limit access from the first intake cavity 4 to the first housing 44 (as shown in FIG. 4). The baffle 18 can further be adapted to minimize any obstruction to the flow of material through the first intake cavity 4.

The baffle 18 can include any type of wall, panel, divider, insert, rib, border, or the like capable of partially inhibiting or affecting the flow of material from the first intake cavity 4 to the first tubular section 8. The baffle 18 can be coupled to the first intake cavity 4, the first tubular section 8, or both. Alternatively, the baffle 18 can be formed as a single monolithic structure that can include the remaining components of the apparatus 2.

The baffle 18 can have a height 18h, a width 18w, and a length 18L. The width 18w can be measured as the distance from an edge of the baffle 18 nearest to the first intake cavity 4 to an edge of baffle 18 nearest to the tubular joint 16. The length 18L can be measured as the distance between two terminating edges of the baffle 18 that contact the inner portion of the first tubular section 8. The height 18h can be measured as the distance between the two sides of the baffle 18 with the greatest surface area (i.e., the thickness of the baffle 18).

In an exemplary and non-limiting illustrative embodiment, the baffle 18 can be disposed within the first intake cavity 4 such that is positioned in a substantially vertical configuration to minimize the amount of surface area the leading edge of the baffle 18 occupies within the cross sectional area of the first intake cavity 4. In this example, the only surface area of the baffle 18 that is exposed to the cross-sectional area of the first intake cavity 4 is the area of the baffle 18 measured by the height 18h and length 18L of the baffle 18. Additionally, the baffle 18 can be disposed within the first tubular section 8 such that fewer than two edges of the baffle 18 directly contact an inner portion of the first tubular section 8. For example the baffle 18 can be formed such that the length 18L can be shorter than the inner diameter of the first tubular section 8.

The baffle 18 can further include two or more baffles of various shapes and sized configured to prohibit an operator from accessing the second intake cavity 6 from the first intake cavity 4 while allowing material to flow between the first intake cavity 4 and second intake cavity 6. Sides of the baffle 18 can take the form of various geometric shapes including but not limited to squares, rectangles, trapezoids, rhombuses, circles, ellipses, and other regular or irregular geometric shapes.

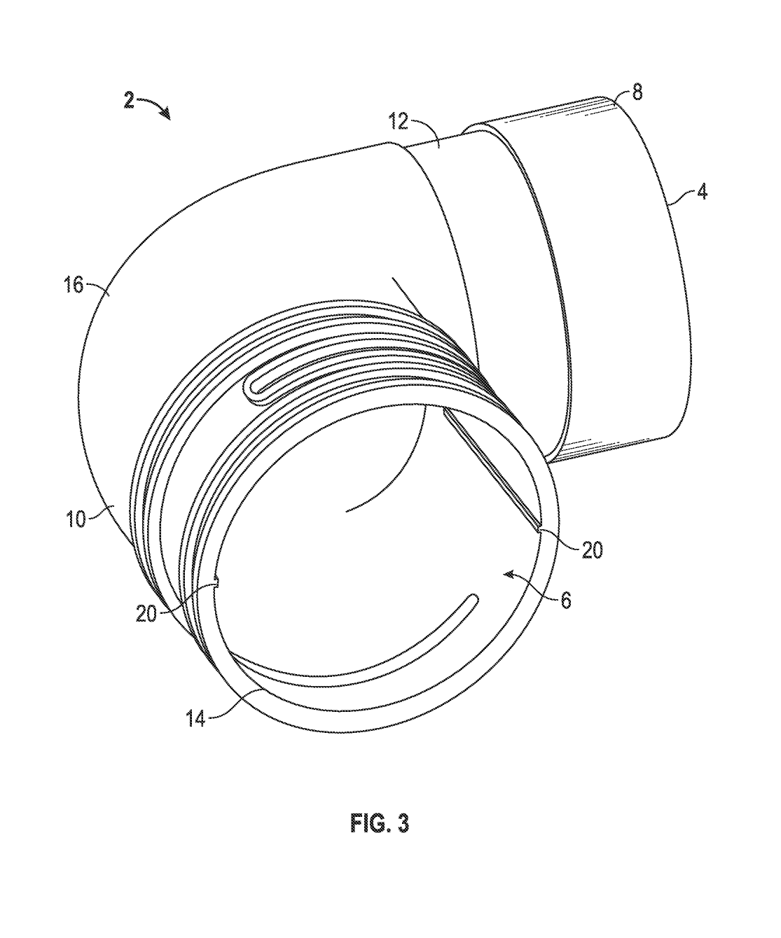

FIG. 3 illustrates an isometric bottom view of a first embodiment of an apparatus for improving the safety of a vacuum device. The apparatus can include a first intake cavity 4, a second intake cavity 6, and a first tubular section 8 that can further include a first tapered section 12. The apparatus 2 can further include a slot 14, a tubular joint 16, and at least one flange 20.

The at least one flange 20 can be adapted to couple the apparatus 2 to the first housing 44 (as shown in FIG. 4). The at least one flange 20 can include any projecting fin, collar, plate, rib, or the like extending inwardly from the interior of the second tubular section 10. Further, the at least one flange 20 can be used to secure the apparatus 2 while it is coupled to the intake interface 42 (as shown in FIG. 4), the first housing 44 (as showing in FIG. 4), or both. Alternatively, the first tapered section 12 can be replaced with at least one coupling element (not shown). The at least one coupling element can include a tab, notch, slot, or any other means for coupling the apparatus 2 to the intake interface 42 (as shown in FIG. 4), the first housing 44 (as showing in FIG. 4), or both. For example, the at least one flange 20 can be replaced by a releasable flexible tab (not shown).

FIG. 4 illustrates a first embodiment of a system for improving the safety of a vacuum device. The system 40 can include an intake interface 42, a first housing 44 that can be adapted to receive a pumping device (not shown), a second housing 46, and an apparatus 2 that can be coupled to the intake interface 42, a first housing 44, or both. The apparatus 2 can further be adapted to be coupled to a conduit 49.

The system 40 can further include a collection unit 48 that can be adapted to collect solid particulates, dust, debris, or the like originating from the conduit 49. The collection unit 48 can include a first collection unit 48a and second collection unit 48b. The second collection unit 48b can be adapted to collect solid particulates originating from the conduit 49.

The first intake interface 42 can include any plate, guard, cover, lid, or the like for covering all or substantially all of the components of a pumping device (not shown). The pumping device can be adapted to be received by the first housing 44. The first intake interface 42 can be adapted to be coupled to, or decoupled from, the first housing 44. The first intake interface 42 can include a cavity (not shown) capable of permitting material to flow from the apparatus 2 to the second housing 46. The cavity can include one or more baffles (not shown) that can prohibit an operator from accessing the first housing 44 when the intake interface 42 is coupled to the first housing 44.

The first housing 44 can include any container, housing, repository, receptacle, or the like capable of housing a pumping device (not shown). The first housing 44 can be coupled to the intake interface 42, the apparatus 2, or both. The first housing 44 can further be coupled to the second housing 46. The pumping device (not shown) is capable of being disposed within the first housing 44.

The pumping device (not shown) can include a motor, pump, or any other device for raising, driving, or compressing air, gas, or other gaseous-like substances. The pumping device can further include one or more blades, propellers, fans, flabellums, or any other device capable of manipulating, regulating, or affecting the flow of air either inside or outside the first housing 44. The pumping device can be employed to create a partial vacuum in order to create suction to force materials, such as solid particularities, air, or other dust or debris, from the conduit 49 to the collector unit 48.

The second housing 46 can include any container, housing, repository, receptacle, or the like that can be adapted to separate material originating from the conduit 49. The second housing 46 can be coupled to the first housing 44, the collection unit 48, or both. The second housing 46 can separate material originating from the conduit 49 by channeling larger, solid particulates, such as saw dust, wood chips, debris, or the like to a first portion of the collection unit 48, while the remaining, smaller debris can be channeled to a second portion of the collection unit 48. Additionally, the second housing 46 can include a filter unit (not shown). The filter unit can include one or more High-Efficiency Particulate Air (HEPA) filters. Alternatively, the filter unit can be disposed within the collection unit 48.

The collection unit 48 can include a first collection unit 48a and a second collection unit 48b. The first collection unit 48a can be coupled to the second collection unit 48b so that first collection unit 48a is stacked vertically above the second collection unit 48b. Alternatively, the first collection unit 48a and the second collection unit 48b can be arranged horizontally. Furthermore, the first collection unit 48a and the second collection unit 48b can be arranged either in series, or in parallel, with respect to one another.

The collection unit 48 can be used as a repository for the storage of material collected originating from the conduit 49. The collection unit 48 can include one or more collection unit bags (not shown) for the removal of material stored in the collection unit 48. The one or more collection unit bags can be releasably coupled to, or decoupled from, the collection unit 48 so that the one or more collection unit bags can be detached and replaced if necessary.

Furthermore, the collection unit 48 can separate material originating from the conduit 49 by channeling larger, solid particulates, such as saw dust, wood chips, debris, or the like to second collection unit 48b, while the smaller debris remaining can be channeled to the first collection unit 48a. The collection unit 48 can channel the material into each of the respective collection units (48a and 48b) through the dual use of gravity and air pressure. That is, by channeling the material containing both solid particulates (such as saw dust, wood chips, debris, or the like) and smaller debris, the collection unit 48 can exploit the force of gravity to pull the larger debris into the second collection unit 48b, while the suction created by the pumping device (not shown) can force the smaller debris to the first collection unit 48a. Alternatively, the collection unit 48 can include more than two collection units.

The conduit 49 can include any hose, tube, pipe, channel, duct, or vent for allowing the passage of material in liquid, solid, gas, or gaseous-like form from one point of the system to another. For example, the conduit can be a vacuum cleaner hose that can be coupled to a vacuum device attachment (not shown). The conduit 49 can be made of a flexible, rigid, or partially rigid material. Additionally, the conduit 49 can be expandable such that its length can vary depending on the needs of an operator.

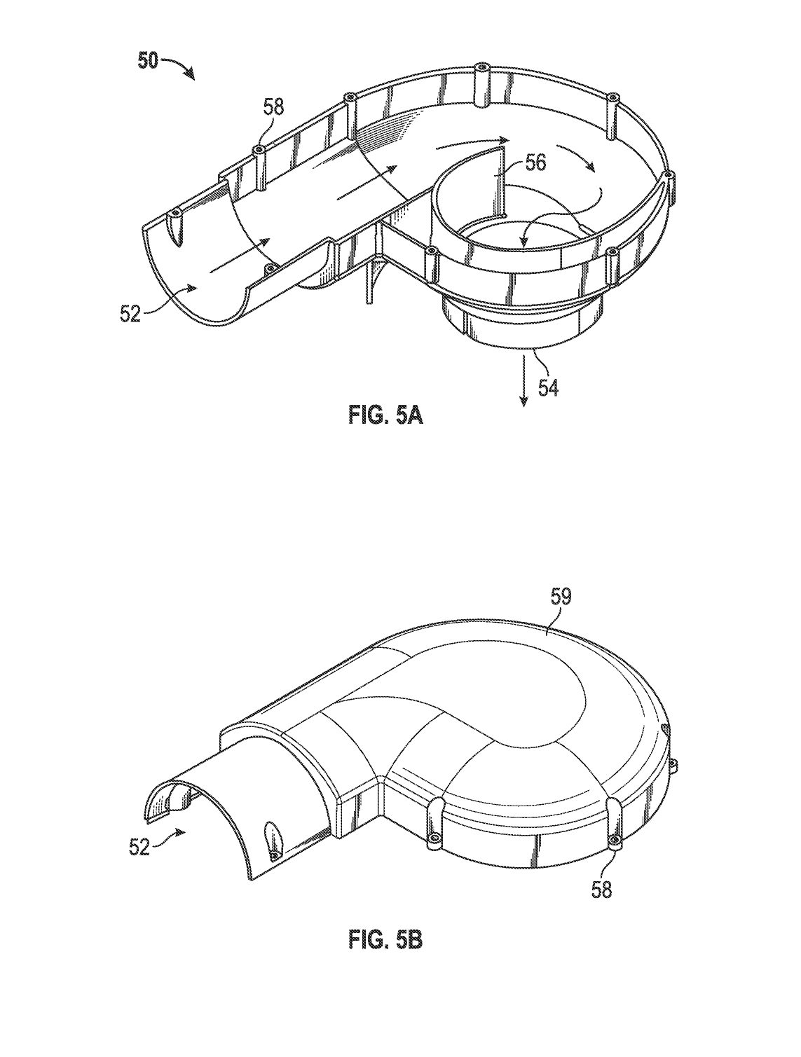

FIG. 5A illustrates an isometric front view of the bottom portion of a second embodiment of an apparatus for improving the safety of a vacuum device. FIG. 5B illustrates an isometric front view of the top portion of a second embodiment of an apparatus for improving the safety of a vacuum device. These figures will be described in conjunction with one another.

The apparatus 50 can include a first intake cavity 52 that can be adapted to be coupled to a conduit 49 (as shown in FIG. 4). The apparatus 50 can further include a second intake cavity 54 that can be adapted to be coupled to an intake interface 42 (as shown in FIG. 4), a first housing 44 (as shown in FIG. 4), or both. The apparatus 50 can further include a baffle 56 that can be adapted to channel solid particulates originating from the first intake cavity 52 to the second intake cavity 54. Furthermore, the apparatus 50 can include a first coupling element 58 and an external cover 59.

The first intake cavity 52 can include any cavity, slot, slit, opening, vent, void, or other recessed or hollow space capable of receiving any solid, liquid, gas, or gaseous-like material (depicted as a series of arrows in the figures). For example, the first intake cavity 52 can be configured to permit solid particulates or other dust, debris, or the like to flow from a conduit 49 (as shown in FIG. 4) through to the second intake cavity 54. In an exemplary and non-limiting illustrative embodiment, the first intake cavity 52 can be configured as a circular opening positioned at a terminating edge of the apparatus 50. Alternatively, the first intake cavity 52 can be configured to be shaped as any other regularly or irregularly geometrically shaped opening capable of receiving solid, liquid, gas, or gaseous-like materials.

The second intake cavity 54 can include any cavity, slot, slit, opening, vent, void, or other recessed or hollow space capable of receiving any solid, liquid, gas, or gaseous-like material. For example, the second intake cavity 54 can be configured to permit solid particulates to flow from the first intake cavity 52 of the apparatus 50. In an exemplary and non-limiting illustrative embodiment, the second intake cavity 54 can be configured as a circular opening positioned at a terminating edge apparatus 50.

The baffle 56 can include any type of wall, panel, divider, insert, rib, border, or the like capable of channeling the flow of material from the first intake cavity 52 to the second intake cavity 54. In an exemplary and non-limiting illustrative embodiment, the baffle 56 can include a panel that partially forms an exterior portion of the apparatus 50. The baffle 56 can be formed as a single monolithic structure that includes the remaining components of the apparatus 50. Alternatively, the baffle 56 can be coupled to, and decoupled from, the remaining portions of the apparatus 50.

The baffle 56 can be adapted to channel solid particulates or other dust, debris, or the like in a partially cyclical fashion, such as in a spiral configuration. For example, the baffle 56 can be shaped in a spiral configuration to form a circle with a gradually decreasing diameter. When shaped in a spiral configuration, the baffle 56 can redirect, bend, curve, deviate, or divert the flow of solid particulates and other materials from the first intake cavity 52 to the second intake cavity 54 with an unrestricted flow. The baffle 56 can form a spiral configuration such that the first intake cavity 52 is located at the same height or at a height that is greater than that of the second intake cavity 54.

Furthermore, the baffle 56 can be adapted to channel solid particulates or other dust, debris, or the like by funneling the solid particulates or other debris from the first intake cavity 52 to the second intake cavity 54. This funneling can be accomplished by shaping the baffle 56 in a spiral configuration to form a circle with a diameter that decreases more rapidly than the partially cyclical fashion as described above. For example, the baffle 56 can be configured to funnel the solid particulates or other debris when the diameter of the circle defined by the spiral is less than 50% of the original diameter for every 360 degrees circumscribed. The baffle 56 can be configured in a partially cyclical fashion when the diameter of the circle defined by the spiral is between 50%-100% of the original diameter for every 360 degrees circumscribed.

The first coupling element 58 can include any screw, snap, hook, button, catch, clasp, bolt, clip, or any other fastener for coupling the external cover 59 to, or decoupling it from, the remaining components of the apparatus 50. The first coupling element 58 can include one or more coupling elements. Furthermore, the first coupling element 58 can be coupled to at least a portion of the baffle 56.

The external cover 59 can include a cover, panel, sheet, or any other divider capable of covering all or a substantial portion of the internal components of the apparatus 50. The external cover 59 can be formed as a solid, monolithic component in order to prohibit an operator from reaching the second intake cavity 54 while still allowing material to flow between the first intake cavity 52 and second intake cavity 54. By coupling the external cover 59 to the remaining components of apparatus 50, apparatus 50 can function as a safety device to prevent an operator from accessing any moving parts when coupled it is to other components of a vacuum system. Additionally, once the external cover 59 is coupled to the remaining components of the apparatus 50, the unique shape of the apparatus 50 can further prevent an operator from accessing any moving parts when it is coupled to other components of a vacuum system.

The apparatus 50 can further include an apparatus fastener (not shown). The apparatus fastener can include any screw, snap, hook, button, catch, clasp, bolt, clip, or any other fastener for securing the apparatus 50 to an intake interface 42 (as shown in FIG. 4), a first housing 44 (as shown in FIG. 4), or both. In an exemplary and non-limiting illustrative embodiment, the apparatus fastener can include one or more hose clamps to secure the apparatus 50 in its place when coupled to other components of a vacuum system.

The apparatus 50 can be made of injection-molded plastic, such as polypropylene, polyethylene, ABS, thermoplastics, polymerizing resin, polyacetal, polystyrene, and/or similar materials, with or without filling additives like fibers, chalks, or other flowable and settlable materials that may be injection-molded, cast, or low-pressure molded, in accordance with conventional practice.

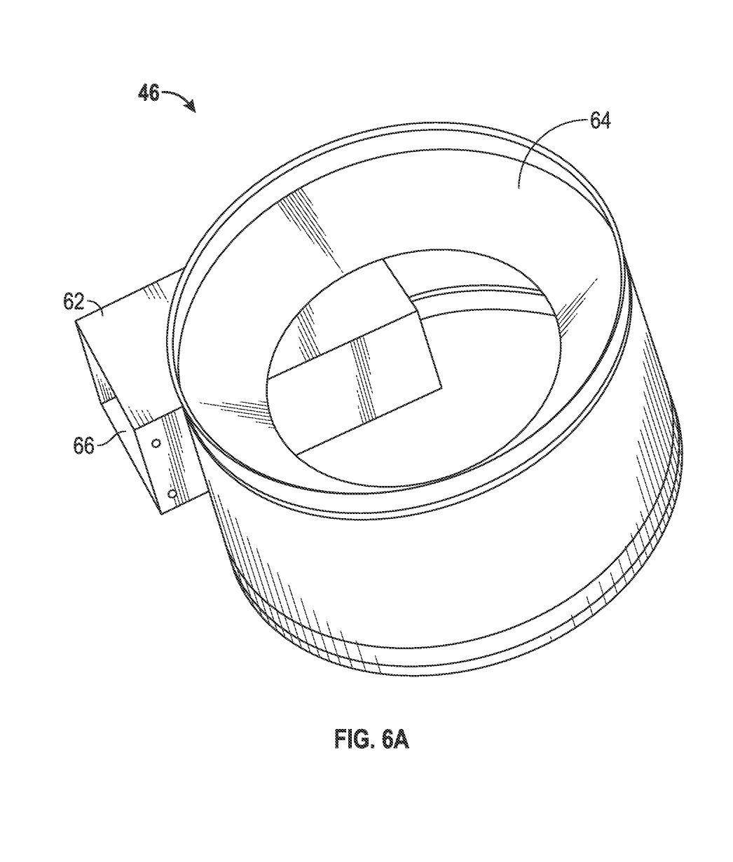

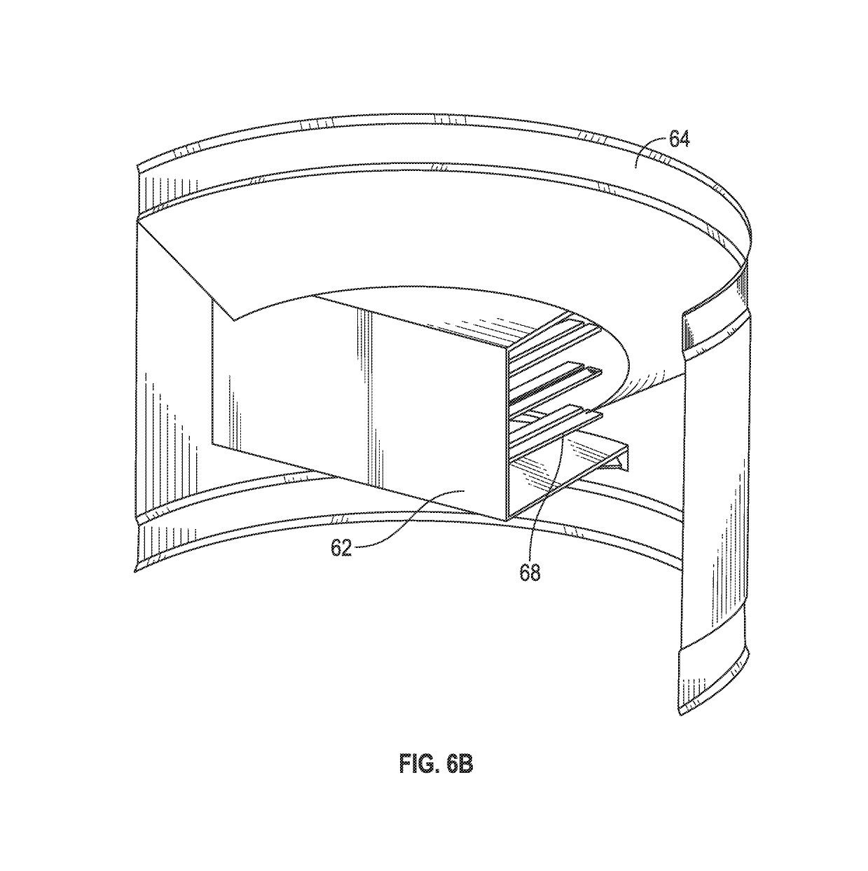

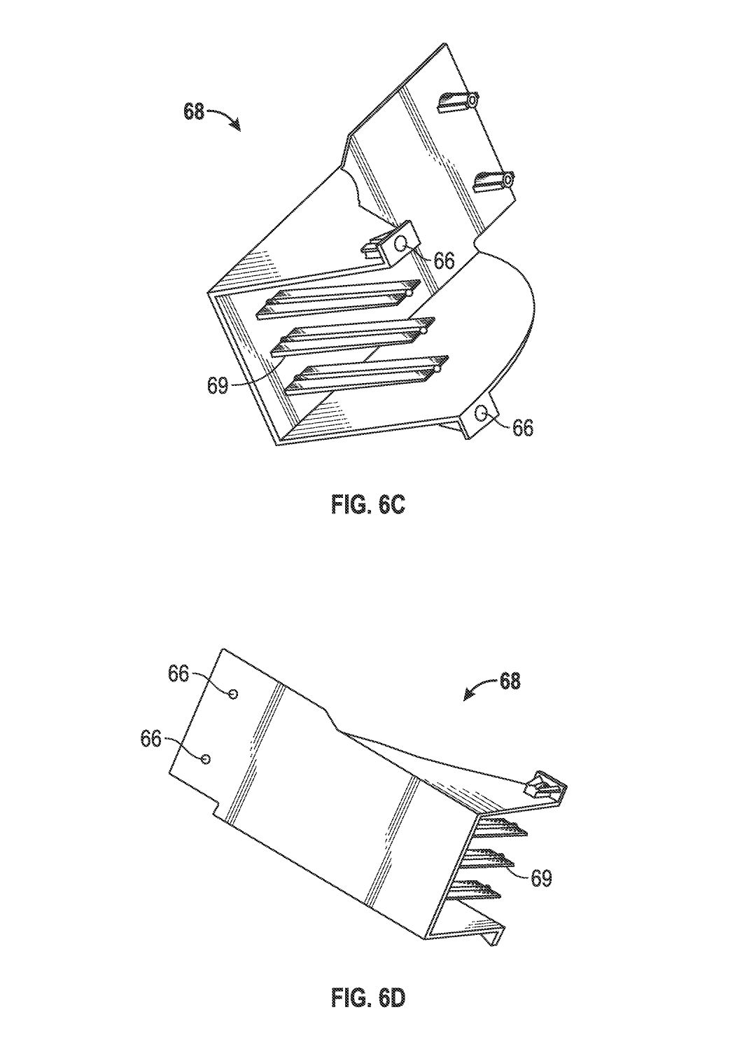

FIG. 6A illustrates an isometric view of a first embodiment of a second housing including a collection unit interface and a safety device. FIG. 6B illustrates a cross-sectional isometric view of a first embodiment of a second housing including a collection unit interface and a safety device. FIG. 6C illustrates an isometric back view of a first embodiment of a safety device flange. FIG. 6D illustrates an isometric front view of a first embodiment of the safety device flange. These figures will be described in conjunction with one another.

The second housing 46 includes a safety device 62 that can be adapted to limit the access from the second housing 46 to the first housing 44 (as shown in FIG. 4), a collection unit interface 64 that can be adapted to be coupled to a collection unit 48 (as shown in FIG. 4), and a second coupling element 66. The safety device 62 can further include a safety device flange 68. The safety device flange 68 can be adapted to prevent access from the second housing 46 to the first housing 44 (as shown in FIG. 4). The safety device flange 68 can further include at least one safety device baffle 69.

The safety device 62 can include a tube, pipe, hollow or partially hollow cylinder, duct, vent, or any other conduit capable of allowing the passage of a solid, liquid, gas, or gaseous-like material from a point of origin to a point of destination. The safety device 62 can be shaped as a cube, rectangular prism, or any other regularly or irregularly-shaped geometric shape. The safety device 62 can further be coupled to the safety device flange 68.

The safety device flange 68 can include any guard, plug, bung, fitting, stopper, or other device that can prohibit an operator from contacting the first housing 44 (as showing in FIG. 4) through the collection unit interface 64. The safety device flange 68 can be shaped as a cube, rectangular prism, or any other regularly or irregularly-shaped geometric shape for prohibiting an operator's access to the collection unit interface 64. In an exemplary and non-limiting illustrative embodiment, the safety device flange 68 can be shaped as a rectangular prism with fewer than six sides. In this example, the safety device flange 68 can be disposed within the safety device 62 without fully obstructing the flow of materials, including solid particulates, from the collection unit interface 64 to the collection unit 48 (as shown in FIG. 4).

The second coupling element 66 can include any screw, snap, hook, button, catch, clasp, bolt, clip, or any other fastener for coupling the safety device flange 68 to, or decoupling it from, the safety device 62. The second coupling element 66 can include one or more coupling elements. The at least one safety device baffle 69 can include one or more baffles that can extend orthogonally or substantially orthogonally from at least one plane of the safety device flange 68. The at least one safety device baffle 69 can include any type of wall, panel, divider, insert, rib, border, or the like capable of partially inhibiting or affecting the flow of material originating from a conduit 49 (as shown in FIG. 4). The at least one safety device baffle 69 can be coupled to the safety device flange 68. Alternatively, the at least one safety device baffle 69 can be formed as a single monolithic structure that includes, at a minimum, the safety device flange 68.

In an exemplary and non-limiting illustrative embodiment, the at least one safety device baffle 69 can be positioned in a vertical configuration to minimize the amount of surface area that the leading edge of the at least one safety device baffle 69 occupies within the cross-sectional area of the safety device 62. The at least one safety device baffle 69 can further include two or more baffles of various shapes and sizes configured to prohibit an operator from reaching through and accessing the collection unit interface 64 while allowing material to flow through the collection unit interface 64. Sides of the at least one baffle 69 can take the form of various geometric shapes including but not limited to squares, rectangles, trapezoids, rhombuses, circles, ellipses, and other regular or irregular geometric shapes. The length of the at least one safety device baffle 69 can be equal to, or less than, the length of the safety device 62.

The collection unit interface 64 can include any cavity, slot, slit, opening, vent, void, or other recessed or hollow space capable of receiving any solid, liquid, gas, or gaseous-like material. For example, the collection unit interface 64 can be configured to permit solid particulates to flow from a conduit 49 (as shown in FIG. 4) through to the collection unit 48. In an exemplary and non-limiting illustrative embodiment, the collection unit interface 64 can be configured as a circular opening positioned at a terminating edge of the second housing 46. Alternatively, the collection unit interface 64 can be configured to be shaped as any other regularly or irregularly geometrically shaped opening capable of receiving solid, liquid, gas, or gaseous-like materials.

The term “coupled,” “coupling,” “coupler,” and like terms are used broadly herein and can include any method or device for securing, binding, bonding, fastening, attaching, joining, inserting therein, forming thereon or therein, or otherwise associating, for example, mechanically, magnetically, electrically, chemically, operably, directly or indirectly with intermediate elements, one or more pieces of members together and can further include without limitation integrally forming one functional member with another in a unitary fashion. The coupling can occur in any direction, including rotationally.

The figures described above and the written description of specific structures and functions below are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

In some alternate implementations, the functions/actions/structures noted in the figures can occur out of the order noted in the block diagrams and/or operational illustrations. For example, two operations shown as occurring in succession, in fact, can be executed substantially concurrently or the operations can be executed in the reverse order, depending upon the functionality/acts/structure involved. Therefore, though not explicitly illustrated in the figures, any and all combinations or sub-combinations of the steps illustrated in FIG. 8, or additional steps described in the figures or the detailed described provided herein, can be performed in any order, with or without regard for performing the other recited steps.

Those of skill in the art should, in light of the present disclosure, appreciate that many changes can be made in the specific embodiments which are disclosed and still obtain a like or similar result without departing from the scope of the invention.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. An apparatus for improving the safety of a vacuum device, the apparatus comprising:
a first intake cavity, wherein the first intake cavity is adapted to be coupled to a conduit;
a second intake cavity, wherein the second intake cavity is adapted to be coupled to a first housing; and
a baffle, wherein the baffle is adapted to be disposed within the first intake cavity in order to limit access from the first intake cavity to the first housing.

2. The apparatus for improving the safety of a vacuum device according to claim 1, further comprising a slot, wherein the slot is adapted to adjust the orientation of the first intake cavity with respect to the first housing.

3. The apparatus for improving the safety of a vacuum device according to claim 1, further comprising a first tubular section and a second tubular section, wherein the diameter of at least a portion of the first tubular section is smaller than the diameter of the second tubular portion.

4. The apparatus for improving the safety of a vacuum device according to claim 1, wherein an interior portion of the second intake cavity comprises a plurality of flanges, wherein the flanges are adapted to couple the apparatus to the first housing.

5. The apparatus for improving the safety of a vacuum device according to claim 1, wherein the baffle is disposed within the first intake cavity to minimize any obstruction to the flow of material through the first intake cavity.

6. The apparatus for improving the safety of a vacuum device according to claim 3, further comprising a tubular joint, wherein the tubular joint is adapted to couple the first tubular section to the second tubular section.

7. The apparatus for improving the safety of a vacuum device according to claim 6, wherein the tubular joint is adapted to be bent an angle of approximately ninety degrees.

8. A system for improving the safety of a vacuum device, the system comprising:
an intake interface;
a first housing, wherein the first housing is adapted to receive a pumping device;
an apparatus adapted to be coupled to the intake interface, the apparatus comprising:
is a first intake cavity, wherein the first intake cavity is adapted to be coupled to a conduit;
a second intake cavity, wherein the second intake cavity is adapted to be coupled to a first housing; and
a baffle, wherein the baffle is adapted to be disposed within the first intake cavity in order to limit access from the first intake cavity to the first housing; and
a collection unit, wherein the collection unit is adapted to collect solid particulates originating from the first intake cavity.

9. The system for improving the safety of a vacuum device of claim 8, further comprising a second housing, wherein the second housing is adapted to separate material originating from the first intake cavity.

10. The system for improving the safety of a vacuum device according to claim 9, further comprising a safety device, wherein the safety device is adapted to limit access from the second housing to the first housing.

11. The system for improving the safety of a vacuum device according to claim 10, wherein the safety device further comprises a safety device flange.

12. The system for improving the safety of a vacuum device according to claim 11, wherein the safety device further comprises at least one safety device baffle.

13. The system for improving the safety of a vacuum device of claim 8, wherein the collection unit comprises a first collection unit and a second collection unit.

14. The system for improving the safety of a vacuum device of claim 13, wherein the second collection unit is adapted to collect dust originating from the first intake cavity.

15. The system for improving the safety of a vacuum device according to claim 8, further comprising a collection unit interface adapted to be coupled to the collection unit.

16. The system for improving the safety of a vacuum device according to claim 8, further comprising a vacuum device, wherein the vacuum device is adapted to be coupled to the conduit.

17. An apparatus for improving the safety of a vacuum device, the apparatus comprising:
a first intake cavity, wherein the first intake cavity is adapted to be coupled to a conduit;
a second intake cavity, wherein the second intake cavity is adapted to be coupled to a first housing; and
a baffle, wherein the baffle is adapted to channel solid particulates originating from the first intake cavity to the second intake cavity.

18. The apparatus for improving the safety of a vacuum device according to claim 17, further comprising an external cover, wherein the external cover is adapted to be coupled to, or decoupled from, at least a portion of the baffle.

19. The apparatus for improving the safety of a vacuum device according to claim 17, wherein the baffle is adapted to channel the solid particulates from the first intake cavity to the second intake cavity in a partially cyclical fashion.

20. The apparatus for improving the safety of a vacuum device according to claim 19, wherein the baffle is adapted to channel the solid particulates by funneling the solid particulates from the first intake cavity to the second intake cavity.
